(19) United States
(12) Patent Application Publication
(10) Pub. No.: US 2008/0260003 A1
(43) Pub. Date: Oct. 23, 2008

(54) Method for Transmitting a Multicarrier Spectrum-Spread Signal, Reception Method, Corresponding Transmitting, Receiving Device and Signal

(75) Inventor: Jean-Yves Baudais, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignees: Universite de Rennes 1, Rennes Cedex (FR); Centre Nationl de la Recherche Scientifique, Rennes Cedex (FR)

(21) Appl. No.: 12/066,959

(22) PCT Filed: Sep. 14, 2006
(86) PCT No.: PCT/EP2006/066385

§ 371 Date: Jul. 3, 2008

(30) Foreign Application Priority Data
Sep. 14, 2005 (FR) 0509463
Nov. 16, 2005 (FR) 0511630

(51) Int. Cl. H04B 1/707

(52) U.S. Cl. 375/146; 375/E01.002

(57) ABSTRACT

A method is provided for transmitting a multicarrier spectrum-spread signal, using a plurality of spreading codes. The method includes a step of allocating a power and/or rate to each of the spreading codes, based on an information representing the noise and/or on an information representing the quality of the link, said allocating step taking into account a target rate.

### CROSS-REFERENCE TO RELATED APPLICATIONS

This application is a Section 371 National Stage Application of International Application No. PCT/EP2006/066385, filed Sep. 14, 2006 and published as WO 2007/031568 on Mar. 22, 2007, not in English.

### STATEMENT REGARDING FEDERALLY SPONSORED RESEARCH OR DEVELOPMENT

None.

### FIELD OF THE INVENTION

The field of the invention is that of multicarrier signals, and in particular signals combining a multiple carrier modulation and code multiple access.

More precisely, the invention presents a technique for transmitting such a multicarrier (for example of the OFDM type (Orthogonal Frequency Division Multiplex)) and spread spectrum signal (for example of the CDMA type (Code Division Multiple Access)).

In other words, the invention relates to the allocation of source data intended to form such multicarrier spread spectrum signals such as the MC-CDMA (Multi Carrier Code Division Multiple Access) signals.

The invention finds in particular applications in all domains implementing broadband transmission and communication techniques.

The invention applies mainly, but not exclusively, to communications in cable networks, such as in networks of the xDSL (Digital Subscriber Line) type, power line communications (home automation, electrical distribution network, etc.), intra-vehicle links, etc.

With the assumption of static or quasi-static transmission channels, the invention also finds applications in wireless communications, such as radiocommunications inside buildings, communications beams, etc.

### BACKGROUND OF THE DISCLOSURE

Current wire transmission techniques are based on the DMT (Digital MultiTone) technology.

According to this technique, a modulation is determined to be applied to each carrier of a multicarrier signal in order to assign the source data, according to the quality of the link (quality of the propagation channel) and of the desired link budget.

However, a major disadvantage of this technique is that the signals formed as such do not resist electromagnetic scramblers well.

In addition, since the recovery of data is implemented carrier by carrier according to the DMT technique, the OFDM multiplex carriers that have a link budget that is too weak (i.e. a signal to noise ratio that is too low for transmitting bits of information) cannot be used. Therefore information cannot be transmitted on these carriers.

Other data allocation techniques in a system implementing a multicarrier modulation have also been disclosed in the articles mentioned in appendix 1, which is an integral part of this description.

### SUMMARY

An embodiment of the invention relates to a method of transmission of a multicarrier spread spectrum signal, implementing a plurality of spreading codes.

According to the invention, such a method comprises a step of attribution of a power or energy and/or a rate to each of the spreading codes, according to information representative of the noise and/or information representative of the quality of the link, said attribution step taking a target rate (global throughput) into account.

As such, the invention is based on an entirely new and inventive approach in distributing source data, intended to form a signal for example of the MC-CDMA type, on the carriers and the spreading codes associated with such a signal.

More precisely, the invention makes it possible to determine the number U of spreading codes needed, the power or energy Eᵤ attributed to each of these codes (where the power corresponds to the energy Eᵤ per unit of time), and/or the rate Rᵤ attributed to each of these codes, according to information representative of the noise, in particular the signal to noise ratio, and/or information representative of the quality of the link, i.e. of the estimate of the transmission channel, and of a target rate R.

The quality of the link depends in particular on the estimate of coefficients hᵢ of the transmission channel, and of the variance N₀ of the noise, assumed to be white Gaussian.

As such, by taking into account the signal to noise ratio (link budget) and/or the estimate of the transmission channel (quality of the link), and of a target rate R, the invention makes it possible to optimize the noise margin γ of the system, by optimising the distribution of energy Eᵤ and/or of the rate Rᵤ attributed to each of the U spreading codes.

This noise margin γ corresponds in particular to the maximum difference between the actual performance of the transmission system and the theoretical performance limits, such as defined by Shannon's theorem. As such, according to the invention, for a desired quality of service QoS (for example a BER of 10⁻⁷), the bit error rate must remain less than this quality, even in the presence of noise.

The target rate R is in particular determined according to the desired application. By way of example, within the framework of an ADSL link, the target rate R to be reached can be 512 bits per OFDM symbol.

More precisely, this target rate R corresponds to the sum of the rates Rᵤ attributed to each of the U spreading codes during the attribution step:

$${\sum }_{u = 1}^{U} {R}_{u} = R$$

It can also be noted that the transmission technique according to the invention based on an optimal distribution of resources is implemented using an algorithm having a linear structure, contrary to algorithms for maximizing the noise margin in the framework of DMT, which have an iterative structure.

The attribution step can also take into account a desired quality of service QoS, determined using a bit error rate (BER) to be complied with, coding gain brought by the channel coding and the various degradations of the emission and receiving system that can be taken into account in the noise margin Λ, etc., which is why optimization of resources is necessary in order to guarantee the best service possible under the required performance constraints for reception.

The attribution step can furthermore take a total power spectral density into account.

This total power spectral density, which can in particular be defined by a standards institute, defines a power mask that the MC-CDMA signal must not exceed. Using this power spectral density and the bandwidth of a subcarrier, a total power or energy E can be defined to be distributed between the various codes. Recall that a multicarrier signal is formed of a temporal succession of symbols comprising a set of data elements, with each of the data elements modulating a signal carrier frequency, with one of the carrier frequencies modulated at a given instant by one of the data elements being called a subcarrier.

This total energy E corresponds to the sum of the energies Eᵤ attributed to each of the U spreading codes during the attribution step:

$${\sum }_{i = 1}^{U} {E}_{u} = E$$

Preferably, the attribution step of a rate comprises, for each of the spreading codes, a step for selecting a modulation scheme for at least some of the subcarriers, and in particular all of the subcarriers of the signal.

For example, the source data to be transmitted is modulated according to a quadrature amplitude modulation, such as 4QAM, 16QAM, 64QAM, 256QAM, etc.

The symbols X_{u,o<u≦U} coming from the quadrature amplitude modulation are then spread by using the spreading codes, in order to form the MC-CDMA signal:

C·X=(c_{i,u})_{0<i≦k,o<u≦U·}^{t}[X₁, . . . , X_{U}]

with C being the spread matrix representative of the spreading codes.

The use of spreading codes thus makes it possible to collectively exploit the subcarriers grouped together by each of the codes, which makes it possible to improve the robustness of the transmission system in noisy environments.

Advantageously, the attribution step comprises the following substeps:
verification if the target rate R can be achieved;
if the target rate can be reached:
   determination of the rate to be attributed to each of the spreading codes:
      if the target rate R is strictly less than twice the length k of the spreading codes, attribution of two bits on each of the R/2 codes;
      otherwise attribution of └R/k┘ bits on each one of the k−(R−└R/k┘k) first codes, and └R/k┘+1 bits on each one of the R−└R/k┘k second codes;

with └.┘ the entire portion.

If the target rate R cannot be reached, i.e. if the theorem 2 shown in appendix 2 is not complied with, it is preferable to modify the desired quality of service QoS and/or the desired target rate R, in order to comply with this theorem 2.

If the target rate R can be reached, the value of the target rate R must be compared with the length of the spreading codes. If this value is strictly less than twice the length of the spreading codes, the distribution is expressed by the relation

$$R = \frac{R}{2} \times 2$$

which means only 2 bits are attributed on each of the R/2 codes, which corresponds to a quadrature amplitude modulation 4QAM.

Preferentially, when said target rate R is greater than or equal to twice the length k of the spreading codes, the attribution step is defined by the equations:

R=(k−(R−└R/k┘k))×└R/k┘+(R−└R/k┘k)×(└R/k┘+1) (12)

Rᵤε{└R/k┘,└R/k┘+1}

with:

R the target rate;

Rᵤ the rate attributed to the spreading code u;

k the length of the spreading codes;

└.┘ the entire portion.

Advantageously, the attribution step also comprises a determination substep of energy Eᵤ representative of the power, or directly of the power (energy per unit of time), to be attributed to each of the spreading codes, expressed in the form:

$${E}_{u} = \frac{{2}^{{R}_{u}} - 1}{{\sum }_{u = 1}^{U} ( {2}^{{R}_{u}} - 1 )} E \qquad ( 11 )$$

with:

E a total energy representative of the total power spectral density;

Rᵤ the rate attributed to said spreading code u;

U the number of spreading codes.

As such, for a total energy E, a target rate R, and a length of code k, the preceding equations (12) and (11) give the distribution of the information Rᵤ and of energies Eᵤ in order to optimize the noise margin γ of a system using an MC-CDMA waveform.

The invention also relates to a signal emitting device implementing the method of transmission described previously.

The invention also relates to a method of receiving a multicarrier spread spectrum MC-CDMA signal, comprising a step for demodulating a signal emitted according to the method of transmission described previously, as well as a corresponding receiving device.

The invention finally relates to a multicarrier spread spectrum MC-CDMA signal, emitted by an emitting device and/or received by a receiving device such as described.

### BRIEF DESCRIPTION OF THE DRAWINGS

Other characteristics and advantages of the invention shall appear more clearly when reading the following description of a preferred embodiment, given as a simple illustrative and non-limited example, and annexed drawings, among which:

FIG. 1 shows an MC-CDMA transmission chain implementing the transmission technique based on the allocation of information according to the invention;

FIGS. 2A to 2D show the noise margin γ according to the length k of the codes, for two target rates R and two lengths L of the ADSL channel, in a transmission chain according to FIG. 1;

FIGS. 3A to 3D show the optimal length k of the codes according to the length L of the ADSL channel for four target rates R;

FIGS. 4A to 4D show the performance of the invention compared to the performance of the techniques of prior art.

### DETAILED DESCRIPTION OF ILLUSTRATIVE EMBODIMENTS

The general principle of the invention is based on the allocation of source data intended to form a multicarrier spread spectrum MC-CDMA signal, using the determination of a number of spreading codes, a distribution of the source data over the codes, and a distribution of the energies or powers (energy/time) attributed to these codes.

In other words, the invention discloses a data allocation algorithm, applied to multicarrier waveforms and using spectrum spread.

Spreading codes are thus allocated to carrier groups, and the spreading code associated with each carrier group is optimized, in order to obtain a target rate R.

As such, according to the invention, for a desired quality of service QoS (for example a BER of 10⁻⁷), the bit error rate must remain below this desired quality, even in the presence of noise.

### 1. General Principle of MC-CDMA Systems

MC-CDMA systems are well known, and are in particular described in documents 1 and 2 mentioned in appendix 1.

According to these documents, a MC-CDMA signal can be seen as the inverse Fourier transform of a CDMA signal.

This digital CDMA signal is noted as C·X, with C=(c_{i,u})_{0<i≦k,o<u≦U} being the spread matrix applied to the vector of complex symbols X=^{t}[X₁, . . . , X_{U}]], and X_{u,o<u≦U} the symbols issued from a quadrature amplitude modulation.

Conventionally, the length k of the spreading codes is equal to the number of subcarriers used. The spreading codes are orthogonal codes that can be extracted from Hadamard matrices with dimensions k×k. The number of codes used is U<k.

### 2. General Principle of the Invention

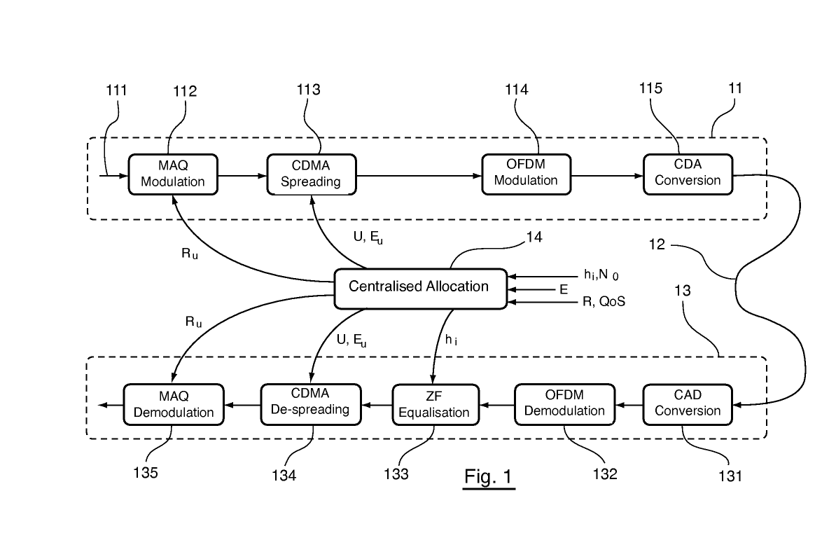

In relation to FIG. 1, a simplified representation is shown of an MC-CDMA transmission chain comprising an emitter 11, a transmission channel 12, and a receiver 13, according to a preferred embodiment of the invention.

It can in particular be noticed that the channel coding and decoding functions, which are not part of the invention, have not been shown in this figure.

As emission, a bit stream 111, comprised of source data to be put into form, enters into a quadrature amplitude modulation block 112. The order of the modulation scheme to be applied to each of the carriers carrying the source data is in particular determined using a centralized allocation block 14, according to this preferred embodiment of the invention.

The symbols X_{u,o<u≦U} stemming from the modulation block 112 are then multiplied by the spread matrix C=(c_{i,u})_{0<i≦k,o<u≦U} in the CDMA spread block 113:

C·X=(c_{i,u})_{0<i≦k,o<u≦U}·^{t}[X₁, . . . , X_{U}].

The number U of spreading codes, as well as the energy Eᵤ attributed to each of these codes, are also determined using the centralized allocation block 14.

The CDMA signal C·X thus obtained is then modulated according to an OFDM modulation in the block 114, in order to form an MC-CDMA signal, then converted into an analogue signal in the DAC block 115, according to this preferred embodiment.

According to the invention, a static or quasi-static transmission channel 12 is considered, and it is supposed that the OFDM component of the MC-CDMA signal is adapted to the transmission channel 12. The channel 12 can then be modelled in the frequency domain with one coefficient per subcarrier, as proposed in document 3 mentioned in appendix 1.

As reception, the analogue signal is converted into a digital signal in the ADC block 131, then undergoes an OFDM demodulation, using a Fourier transform and the guard interval is suppressed, in the block 132.

A ZF equalizer 133 (zero forcing) is then used which inverses the transmission channel 12, in order to equalize the signal obtained.

The equalized signal is then de-spread in a de-spreading CDMA block 134, taking into account the number U of spreading codes, and of the energy Eᵤ attributed to each of these codes, determined using the centralized allocation block 14.

After OFDM demodulation 132, ZF equalization 133, and de-spreading 134, the signal received by the code U is written:

$${Y}_{u} = {kX}_{u} + {\sum }_{i = 1}^{k} {c}_{i , u} \frac{{Z}_{i}}{{h}_{i}} \qquad ( 1 )$$

with:
k being the length of the code u;
Xᵤ the symbols stemming from the QAM modulation, 0<u≦U;
(c_{i,u}) the coefficients of the spread matrix C, 0<i≦k, 0<u≦U;
Zᵢ, a complex sample of background noise, assumed to be white and Gaussian;
hᵢ the coefficients of the transmission channel.

The variance of the complex sample Zᵢ is denoted as N₀.

The signal Yᵤ received by each of the spreading codes then undergoes a QAM demodulation 135, taking into account the order of the modulation scheme determined using the centralized allocation block 14.

According to this preferred embodiment of the invention, the allocation block 14 thus makes it possible to determine:
the number U of spreading codes to be used;
the order of the modulation to be applied to the carriers, i.e. a rate Rᵤ to be attributed to each of the spreading codes; and
the energy Eᵤ to be attributed to each of the spreading codes;

according to information representative of the noise and/or information representative of the quality of the link, and of the target rate R to reach.

Thus the MC-CDMA system is dimensioned according to this target rate, which makes it possible to optimize the noise margin. Maximizing the rate is therefore not sought, but rather to optimize the noise margin by reaching this target rate.

More precisely, the information representative of the quality of the link depends on the quality of the estimate of the transmission channel, i.e. the parameters hᵢ and N₀.

The information representative of the noise depends in particular on the link budget, i.e. on the signal to noise ratio output from the transmission system.

According to this preferred embodiment of the invention, the centralized allocation block 14 takes into account a target rate R and a quality of service QoS (for example a BER of about 10⁻⁷) to be reached, defined according to the application under consideration, and a total power spectral density, represented by the total energy E, not to be exceeded, defined by standards institutes.

It is therefore assumed, according to this preferred embodiment, the use of a power mask at emission, limiting the total power spectral density (PSD) of the signal emitted. This constraint is important, since it is within this framework that the allocation of the information is carried out. The amplitude of the signal received thus depends on the number of subcarriers k.

As such, according to the invention, the spreading provides power, which complies with the constraint, not in total power transmitted, but in power spectral density.

It can also be noted that the spectrum spread is well known for its robustness in scrambled environments.

The use of spreading codes thus makes it possible to collectively exploit the carriers grouped together by this same code, contrary to the techniques of the prior art which require processing carrier by carrier.

As previously indicated, the invention in particular makes it possible to find the number of spreading codes, the distribution of the modulation schemes on the codes, and the distribution of the energies attributed to these codes, under the constraint of a target rate and possibly under the constraint of a power spectral density.

It is considered in particular that the distribution referred to as “optimal” maximizes the noise margin of the transmission system for a given length of code, i.e. maximizes the difference between the actual performance of the transmission system and the theoretical performance obtained via Shannon's limit.

### 3. Example of an Application in Terms of an ADSL Link

Hereinafter is presented an example application of the invention in terms of an ADSL (Asymmetric digital subscriber loop) link.

The maximum number of subcarriers that can be used is 220, and an example target rate R is 512 bits per OFDM symbol. Considering document 4 mentioned in appendix 1, the maximum order of the modulation scheme is 32768QAM.

512 bits must therefore be distributed over a maximum of 220 codes, with a maximum of 15 bits per code, due to the maximum order of the QAM scheme.

According to conventional techniques, a complete search for the optimal distribution requires testing of 3,380,629,853,852,186 combinations. This method of searching for the optimal distribution therefore cannot be considered.

According to the invention, it is considered that a calculation of the capacity, or more precisely of the achievable rate, of the transmission system taking the receiver and the noise margin into account is written as:

$$R = {\sum }_{u = 1}^{U} {R}_{u} = {\sum }_{u = 1}^{U} {log}_{2} ( 1 + \frac{1}{γΓ} \frac{{k}^{2}}{{\sum }_{i = 1}^{k} \frac{1}{{\vert {h}_{i} \vert}^{2}}} \frac{{E}_{u }}{{N}_{0}} ) \qquad ( 2 )$$

with:

R being the target rate;

U the number of spreading codes;

Rᵤ the rate attributed to the spreading code U;

k the length of the spreading code;

hᵢ the estimate of the coefficients of the transmission channel;

γ the noise margin of the transmission system;

Λ the noise margin of the QAM modulations, as described in document 3 mentioned in appendix 1;

Eᵤ the energy attributed to the spreading code U.

It is noted in particular that the noise margin Λ can also take into account the gain contributed by the channel coding.

As such, in equation (2), the unknowns are Rᵤ, Eᵤ, U, and we are looking to optimize the noise margin γ of the transmission system.

The constraint of a total power spectral density, i.e. of a jig (calibre) or of a power mask of the emission signal, can be written in the form of a total energy E representative of the power spectral density:

$${\sum }_{u = 1}^{U} {E}_{u} = E \qquad ( 3 )$$

or by using equation (2):

$${\sum }_{u = 1}^{U} {E}_{u} - γΓ \frac{{\sum }_{i = 1}^{k} \frac{1}{{\vert {h}_{i} \vert}^{2}}}{{k}^{2}} {N}_{0} {\sum }_{u = 1}^{U} ( {2}^{{R}_{u}} - 1 ) = E \qquad ( 4 )$$

The noise margin γ is then written as:

$$γ = \frac{1}{{\sum }_{u = 1}^{U} ( {2}^{{R}_{u}} - 1 )} \frac{1}{Γ} \frac{{k}^{2}}{{\sum }_{i = 1}^{k} \frac{1}{{\vert {h}_{i} \vert}^{2}}} \frac{E}{{N}_{0}} \qquad ( 5 )$$

Maximizing γ is the same in fact as minimizing the term

$${\sum }_{u = 1}^{U} ( {2}^{{R}_{u}} - 1 )$$

(called first adding), and/or in minimizing the term

$${\sum }_{i = 1}^{k} \frac{1}{{\vert {h}_{i} \vert}^{2}}$$

(called second adding).

The second adding is simple to minimize, it is sufficient to choose hᵢ such that:

∀iε[1;k],∀j∉[1;k],|hᵢ|≧|hⱼ|

To minimize the first adding, it is possible to use theorem 1 such as presented in appendix 2, which is an integral part of this description:

Theorem 1: Under the constraint

$${\sum }_{u = 1}^{U} {R}_{u} = R , {\sum }_{u = 1}^{U} ( {2}^{{R}_{u}} - 1 )$$

is minimal if and only if k−(R−└R/k┘k) values of Rᵤ are equal to └R/k┘, and R−└R/k┘k values of Rᵤ are equal to └R/k┘+1.

It then remains to distribute the energy E between the codes, or between the symbols, relatively to the order of modulation, i.e. relatively to the distribution of the bits.

By using the expression of Eᵤ equation (4), and using equation (5), we obtain:

$${E}_{u} = \frac{{2}^{{R}_{u}} - 1}{{\sum }_{u = 1}^{U} ( {2}^{{R}_{u}} - 1 )} E \qquad ( 11 )$$

As such, for a given power spectral density (PSD) expressed by a total energy E, a target rate R, and a length of code k, it is possible to define the distribution of information Rᵤ and the energies Eᵤ to be attributed to each of the U spreading codes in order to optimize the noise margin γ of a system using a MC-CDMA waveform.

The distribution of the information is therefore as follows:

R=(k−(R−└R/k┘k))×└R/k┘+(R−└R/k┘k)×(└R/k┘+1) (12)

Rᵤε{└R/k┘,└R/k┘+1}

with └.┘ the entire portion.

There remains however a particular case, that of PSK2, which cannot be used in the applications, which means that the minimum number of bits allocated according to the invention is 2, not 1.

Indeed, the distance between Shannon's limit and the rate achievable using this kind of modulation is greater than that of modulations of a higher order. It is therefore not possible to use the equation (12) when Rᵤ=1 exists, i.e. when └R/k┘ε{0,1}, or R<2×k.

In this particular case, the distribution is simply:

$$R = \frac{R}{2} \times 2 \qquad ( 13 )$$

i.e. there are R/2 codes carrying 2 bits, which corresponds to quadrature amplitude modulation of 4 order (4QAM).

It can also be noted that an odd rate R<2×k cannot be allocated.

Moreover, the achievability of the target rate R has been assumed up until now.

It is however preferable to initially test if the target rate R can be reached or not, using theorem 2 such as presented in appendix 2, which is an integral part of this description.

Theorem 2: Rate R can be reached if and only if:

$$R \leq ⌊ k ( {2}^{/ k - ⌊ / k ⌋} - 1 ) ⌋ + k ⌊ / k ⌋ with = k {log}_{2} ( 1 + \frac{1}{Γ} \frac{k}{{\sum }_{i = 1}^{k} \frac{1}{{\vert {h}_{i} \vert}^{2}}} \frac{E}{{N}_{0}} )$$

As such, according to the preferred embodiment of the invention, the centralized allocation algorithm 14 has the following structure:

1. Input: R, Λ, E, k, hᵢ, N₀;

2. Check if the target rate is achievable: if the rate cannot be reached, change the quality of service QoS (Λ) or the target rate R so that it complies with theorem 2;

3. If R<2k, then attribute 2 bits (4QAM) on each of the R/2 codes;

4. Otherwise, attribute └R/k┘ bits on each of the k−(R−└R/k┘k) codes, and └R/k┘+1 bits on each of the R−└R/k┘k other codes;

5. Calculate the distribution of energies, according to equation (11);

6. Output: U, Rᵤ, Eᵤ.

For example, consider an ADSL link having for transfer function:

hᵢ_{_{f}}=10^{-5.10}^{^{−5}}^{L}⁽2.5{square root over (0.43125i^{_{f}})}^{+4.2)} (15)

with L being the length of the line (in metres), and i_{f}ε[35;64[∪]64;255] the index of the subcarrier, noting as iε[0;220[ the indices corresponding to the i_{f} indexes.

Let R 512 bits/symbols, Λ=4.04 (which corresponds to a symbol error rate of about 10⁻³), E=−39 dBm/Hz, k=100, and N₀=−140 dBm/Hz.

So, for a length of line L of 3000 metres, theorem 1 and equation (11) are used to obtain a number of codes U=100, with 88 codes such as Rᵤ=5 and Eᵤ=8.898×10⁻³ E, and 12 codes such as Rᵤ=6 and Eᵤ=1.808×10⁻² E.

The noise margin is in this case γ=45.5, i.e. 16.6 dB of additional noise margin.

It could in particular be considered that the MC-CDMA system does not allow, per se, to obtain a noise margin that is better than that obtained with the DMT systems of prior art. But added to the noise margin, the spread gain confers greater robustness to the system.

As such, results have already shown the advantage of the MC-CDMA system in scrambled environments even in the absence of allocation optimization, such as indicated in documents 6 and 7 presented in appendix 1.

The invention makes it possible to improve these results further.

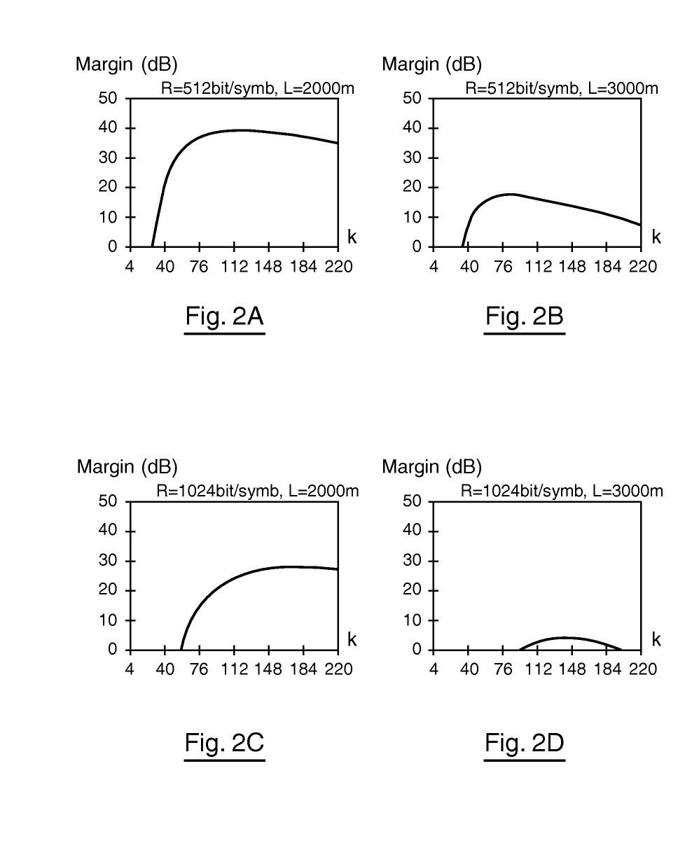

A few simulation results of an example of an application of the invention in the ADSL context are shown in relation with FIGS. 2 to 4.

FIGS. 2A to 2D show in particular the noise margin γ according to the length k of the codes, for two target rates R and two lengths L of the ADSL channel.

As such, FIG. 2A shows the evolution in the noise margin γ according to the length k, for a rate R of 512 bits/symbols and a length of channel L of 2000 metres, FIG. 2B for a rate R of 512 bits/symbols and a length of channel L of 3000 metres, FIG. 2C for a rate R of 1024 bits/symbols and a length of channel L of 2000 metres, and FIG. 2D for a rate R of 1024 bits/symbols and a length of channel L of 3000 metres.

It can thus be observed that there exists an optimal value of k for each configuration making it possible to optimize the noise margin.

For example:
for the configuration in FIG. 2A, the optimal value of k is approximately 130;
for the configuration in FIG. 2B, the optimal value of k is approximately 90;
for the configuration in FIG. 2C, the optimal value of k is approximately 175; and

for the configuration in FIG. 2D, the optimal value of k is approximately 125.

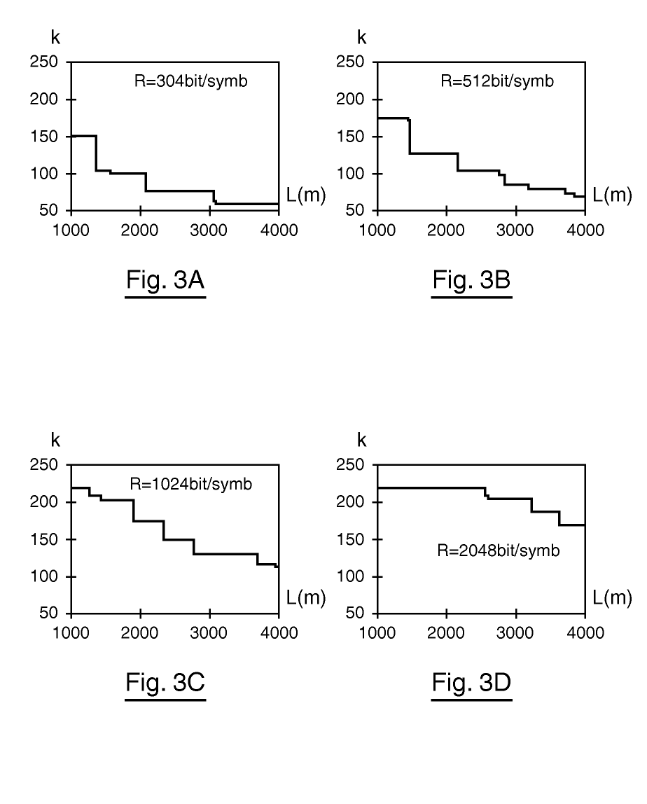

These values are also given in relation with FIGS. 3A to 3D, which show the optimal length k of the codes according to the length L of the ADSL channel for four target rates R (304 bits/symbols—FIG. 3A, 512 bits/symbols—FIG. 3B, 1024 bits/symbols—FIG. 3C, and 2048 bits/symbols—FIG. 3D).

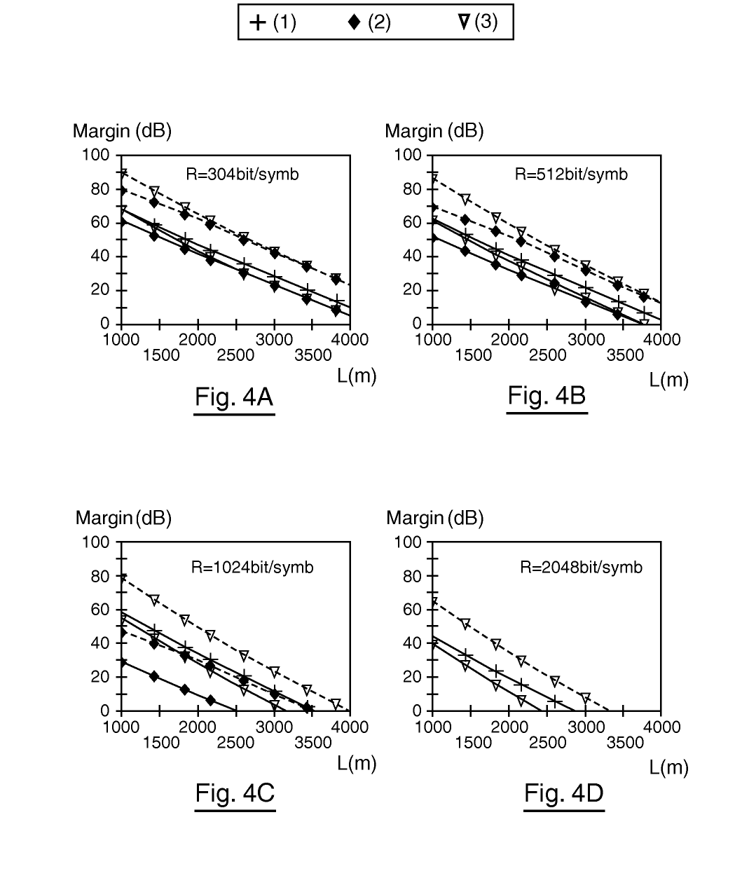

Finally, FIGS. 4A to 4D show the performance of the invention in an MC— CDMA system implementing an attribution of a rate and/or of a power to each of the spreading codes according to the invention, compared to the performance of the techniques of the prior art in a system of the DMT type.

In particular, FIGS. 4A to 4D show the margin for the systems in dB according to the length of the ADSL channel for four target rates R (304 bits/symbols FIG. 4A, 512 bits/symbols—FIG. 4B, 1024 bits/symbols—FIG. 4C, and 2048 bits/symbols—FIG. 4D).

As such:
curve 1 (+) shows the noise margin of a transmission system according to the DMT technique according to the length L of the channel;
curve 2 (♦) shows the noise margin of a transmission system according to the MC-CDMA technique with a length of code k fixed (k=64) according to the length L of the channel; and
curve 3 (∇) shows the noise margin of a transmission system according to the MC-CDMA technique with a length of code k optimal for each length of the channel;

with the noise margin γ plotted as a solid line, and the noise margin combined with the spreading gain plotted as a dotted line.

It can be observed in these figures that the invention makes it possible to optimize the noise margin γ of the system, thanks to an optimal distribution of energies Eᵤ and of rates Rᵤ onto the U spreading codes.

As such, the invention confers to communications greater robustness in environments that are disturbed by electromagnetic scramblers.

Moreover, this transmission technique based on an attribution of rate and/or energy to each of the spreading codes offers all of its interest in systems that multiplex several basic MC-CDMA modules in the frequency domain, as presented in document 8 mentioned in appendix 1.

This transmission technique can also be implemented for various channels (ADSL, PLC (power line communications), etc.), in a point-to-multipoint or multipoint— to-point context (communication to multiple users, respectively for broadcast or access), especially with frequency multiplexing.

The over-layer linked to the multi-user context is not a part of this invention.

The invention thus confers a greater degree of robustness to communications in environments that are disturbed by electromagnetic scramblers, and especially cable communications.

Recall that since the invention requires knowledge of the channel at emission, it is commonly admitted that this type of technology is more adapted to wire communications.

But this is not exclusive: radiocommunications inside buildings, as well as communication beams can be carried out through static channels, in relation to the rate of communications. As such, the invention can be considered for certain wireless communications.

The invention can also be used in systems where the number of subcarriers is greater than the length of the codes.

Also, several blocks of subcarriers can be defined, each block forming an MC-CDMA system, with the entire system known under the acronym SS-MC-MA (spread spectrum multicarrier multiple access). The invention can then apply on each block.

### 4. Appendix 1

1 N. Yee, J-P. Linnartz and G. Fettweis
   “Multi-carrier CDMA in indoor wireless radio networks”
   In IEEE Personal, Indoor and Mobile Radio Communications Symposium, pages 109-113, September 1993.
2 S. Hara and R. Prasad
   “Overview of multicarrier CDMA”
   IEEE Communications Magazine, vol. 35, no. 12, pages 126-133, December 1997.
3 J. M. Cioffi
   “A multicarrier primer”
   Rapport, ANSI T1E1.4/91-157, Committee contribution, 1991.
4 G992-3
   “Asymmetrical Digital Subscriber Line (ADSL) transceivers”
   International Telecommunication Union, 2002.
M. Crussière, J-Y. Baudais and J-F. Helard
   “Robust and high-bit rate communications over PLC channels: A Bitloading multi-carrier spreadspectrum solution”
   In International Symposium on Power-Line Communications and Its Applications, (Vancouver, Canada), April 2005.
6 S. Mallier, F. Nouvel, J-Y. Baudais, D. Gardan and A. Zeddam
   “Multicarrier CDMA over lines—Comparison of performances with the ADSL system”
   In IEEE International Workshop on Electronic Design, Test and Applications, pages 450-452, January 2002.
7 J-Y. Baudais
   “Amélioration de la robustesse du systeme ADSL en présence de brouilleurs: utilisation des techniques MC-CDMA”
   In Colloque GRETSI, Groupe de recherche et d'etude de traitement du signal, September 2003.
8 O. Isson, J-M. Brossier and D. Mestdagh
   “Multi-carrier bit-rate improvement by carrier merging”
   Electronics Letters, vol. 38, no. 19, pages 1134-1135, September 2002.

### 5. Appendix 2

Theorem 1:

Under the constraint

$${\sum }_{u = 1}^{U} {R}_{u} = R , {\sum }_{u = 1}^{U} ( {2}^{{R}_{u}} - 1 )$$

is minimal if and only if k−(R−└R/k┘k) values of Rᵤ are equal to └R/k┘, and R−└R/k┘k values of Rᵤ are equal to └R/k┘+1.

Demonstration:

Let R=kq+r with q=└R/k┘ and

$$f ( 0 ) = ( k - r ) {2}^{q} + r {2}^{q + 1} = {\sum }_{u = 1}^{k} {2}^{{R}_{u}} \qquad ( 6 )$$

with Rᵤε{q,q+1} and └.┘ the entire portion. The demonstration is carried out ad absurdum.

Let a≧1. Suppose that there exists Rᵢ=q and Rⱼ=q such that Rᵢ becomes q+a and Rⱼ becomes q−a, implying ƒ(0)>ƒ(a)=(k−r−2)2^{q}+2^{q+a}+2^{q-a}+r2^{q+1}.

The total number of bits is still equal to R.

ƒ(a)−ƒ(0)=−2×2^{q}+2^{q+a}+2^{q-a}

ƒ(a)−ƒ(0)=2^{q-a}(2^{a+1}(2^{a-1}−1)+1) (7)

As a≧1, then ƒ(a)−ƒ(0)>0, which results in a contradiction. Thus [symbol] Rᵢ>q, [symbol] Rⱼ<q such that ƒ(0)>ƒ(a).

By using the same analysis for the following cases:

$$\begin{matrix}\{ \begin{matrix}{R}_{i} - q & a & q + a \\ {R}_{j} = q + 1 & a & q + 1 - a\end{matrix} \\ and & ( 8 ) \\ \{ \begin{matrix}{R}_{i} = q + 1 & a & q + 1 + a \\ {R}_{j} = q & a & q - a\end{matrix} \\ and & ( 9 ) \\ \{ \begin{matrix}{R}_{i} = q + 1 & a & q + 1 + a \\ {R}_{j} = q + 1 & a & q + 1 - a\end{matrix} & ( 10 )\end{matrix}$$

the same conclusion is obtained. The function ƒ is minimal in zero, and the corresponding distribution of bits also minimizes

$${\sum }_{u = 1}^{k} ( {2}^{{R}_{u}} - 1 ) . If q \neq 0 ,$$

the number of codes used is U=k.

Theorem 2:

The rate R can be reached if and only if R≦└k(2 [symbol] ^{/k-└} [symbol] ^{/k┘}−1)┘+k└ [symbol] /k┘ with

$$= k {log}_{2} ( 1 + \frac{1}{Γ} \frac{k}{{\sum }_{i = 1}^{k} \frac{1}{{\vert {h}_{i} \vert}^{2}}} \frac{E}{{N}_{0}} ) .$$

Demonstration:

Since this portion is not the subject of this patent application, only the principles of the demonstration will be provided. Document 5 mentioned in appendix 1 provides a more thorough demonstration.

By working with the set of real numbers, and using Lagrange multipliers, it is shown that the maximum rate is:

$$= k {log}_{2} ( 1 + \frac{1}{Γ} \frac{k}{{\sum }_{i = 1}^{k} \frac{1}{{\vert {h}_{i} \vert}^{2}}} \frac{E}{{N}_{0}} ) \qquad ( 14 )$$

It is evident that attributing └ [symbol] /k┘ bits on each of the k codes results in an achievable rate. But can more information be transmitted? The problem entails in fact searching for the whole number n such that the constraint of power spectral density is satisfied, and that the following equations are verified:

$$\begin{matrix}\begin{matrix}E - {\sum }_{u = 1}^{k} {E}_{u} = \frac{k}{α} ( {2}^{/ k} - 1 ) - \frac{n}{α} ( {2}^{⌊ / k ⌋ + 1} - 1 ) - \\ \frac{k - n}{α} ( {2}^{⌊ / k ⌋} - 1 ) \geq 0\end{matrix} \\ \begin{matrix}E - {\sum }_{u = 1}^{k} {E}_{u} = \frac{k}{α} ( {2}^{/ k} - 1 ) - \frac{n + 1}{α} ( {2}^{⌊ / k ⌋ + 1} - 1 ) - \\ \frac{k - ( n + 1 )}{α} ( {2}^{⌊ / k ⌋} - 1 ) < 0\end{matrix}\end{matrix}$$

which results in n=└k(2 [symbol] ^{/k-└} [symbol] ^{/k┘}−1)┘

### 6. Conclusion

An aspect of the disclosure proposes technique for transmitting a multicarrier spread spectrum signal making it possible to optimize the distribution of source data over the spreading codes.

In particular, an aspect of the disclosure provides such a technique making it possible to attribute a power and/or an optimal rate to each of the spreading codes.

A further aspect of the disclosure implements such a technique making it possible to optimize a noise margin of the transmission system for a given length of spreading codes. This noise margin corresponds in particular to the maximum difference possible between the actual performance of the transmission system, operating with a certain bit error rate, and the theoretical performance of the transmission system, defined by Shannon's limit.

Another aspect of the disclosure proposes such a technique of transmission presenting better performance in relation to the techniques of prior art, and in particular better resistance to electromagnetic scramblers.

Although the present disclosure has been described with reference to one or more examples, workers skilled in the art will recognize that changes may be made in form and detail without departing from the scope of the disclosure and/or the appended claims.

1. Method of transmitting a multicarrier spread spectrum signal, implementing a plurality of spreading codes, wherein the method comprises:
a step of attribution of a power and/or of a rate to each one of said spreading codes, according to information representative of noise and/or information representative of a quality of the link, said attribution step taking a target rate and a maximized noise margin into account.

2. Method of transmitting set forth in claim 1, wherein said attribution step also takes a total power spectral density into account.

3. Method of transmitting as set forth in claim 1, wherein said step of attribution of a rate comprises, for each of said spreading codes, a step for selecting a modulation scheme for at least some subcarriers of said signal.

4. Method of transmitting as set forth in claim 1, wherein said attribution step comprises the following substeps:
verification if said target rate R can be achieved;
if said target rate can be reached:
determination of said rate to be attributed to each one of said spreading codes:
if said target rate R is strictly less than twice the length k of the spreading codes, attribution of two bits on each of the R/2 codes;
otherwise attribution of └R/k┘ bits on each one of k−(R−└R/k┘k) first codes, and └R/k┘+1 bits on each one of R−└R/k┘k second codes;
with └.┘ the entire portion.

5. Method of transmitting set forth in claim 4, wherein, when said target rate R is greater than or equal to twice the length k of the spreading codes, said attribution step is defined by the equations:
R=(k−(R−└R/k┘k))×└R/k┘+(R−└R/k┘k)×(└R/k┘+1)
Rᵤε{└R/k┘,└R/k┘+1};
with:
R being said target rate;
Rᵤ the rate attributed to said spreading code u;
k the length of said spreading code;
└.┘ the entire portion.

6. Method of transmitting as set forth in claim 4, wherein said attribution step also comprises a determination substep of an energy Eᵤ representative of said power to be attributed to each one of said spreading codes, expressed in the form:
$${E}_{u} = \frac{{2}^{{R}_{u}} - 1}{{\sum }_{u = 1}^{U} ( {2}^{{R}_{u}} - 1 )}$$
with:
E being total energy representative of said total power spectral density;
Rᵤ the rate attributed to said spreading code u;
U the number of spreading codes.

7. Device for emitting a multicarrier spread spectrum signal, implementing a plurality of spreading codes, wherein the device comprises means of attribution of a power and/or of a rate to each one of said spreading codes, taking a target rate and a maximized noise margin into account, according to information representative of the noise and/or information representative of the quality of the link.

8. Method comprising:
receiving a multicarrier spread-spectrum signal, implementing a plurality of spreading codes, a power and/or a rate being attributed before emission to each one of said spreading codes according to information representative of noise and/or information representative of a quality of the link and by taking a target rate and a maximized noise margin into account, and
demodulating said signal taking into account said power and/or said rate attributed to each one of said spreading codes.

9. Device for receiving a multicarrier spread spectrum signal, implementing a plurality of spreading codes,
a power and/or a rate being attributed before emission to each one of said spreading codes according to information representative of noise and/or information representative of a quality of the link and by taking a target rate and a maximized noise margin into account,
wherein the device comprises means of demodulation of said signal taking into account said power and/or said rate attributed to each one of said spreading codes.

10. Method comprising:
generating a multicarrier spread-spectrum signal, comprising a plurality of spreading codes, wherein each one of said spreading codes is associated to a power and/or to a rate, attributed according to information representative of noise and/or information representative of a quality of the link, and taking a target rate and a maximized noise margin into account; and
transmitting the signal.
